(19) United States
(12) Patent Application Publication
(10) Pub. No.: US 2016/0275502 A1
(43) Pub. Date: Sep. 22, 2016

(54) EMBEDDED THIRD PARTY SERVER BYPASS SECURITY FEATURE

(71) Applicant: Quisk, Inc., Sunnyvale, CA (US)

(72) Inventor: Praveen Amancherla, Cupertino, CA (US)

(21) Appl. No.: 14/661,357

(22) Filed: Mar. 18, 2015

(51) Int. Cl. G06Q 20/40

(52) U.S. Cl. CPC G06Q 20/401; G06Q 2220/00

(57) ABSTRACT

A process for managing a payment transaction between a payor and payee is described. A payment processing interface hosted by a transaction server not controlled by the payee is embedded within a user interface of the payee. Information relating to the transaction, which includes an amount of the transaction, is obtained. The payment processing interface is displayed within the user interface and includes the amount of the transaction and prompt(s) for payor payment account information. Encrypted payment account information is sent from the payor to the transaction server in response to the prompt(s) without exposing said information to outside parties. The payment account information is decrypted at the transaction server and used to process the transaction. The transaction server provides an indicator of success or failure of the transaction to the payor and stores a record of the transaction for subsequent review by the payee.

### BACKGROUND

Electronic payments in the form of credit card transactions and other alternatives payment methods are ubiquitous in the modern economy and are rapidly expanding into the furthest recesses of the developing world. Electronic payments provide numerous benefits in the form of added convenience and security. Unlike cash, means for conducting electronic payments are generally tied to a person's identity, which therefore adds an additional layer of security. For instance, whether an electronic payment is conducted may be conditioned upon receipt of various items of user or account information that are specific to a user making the payment, such as a password, a PIN (personal identification number), or the like.

Electronic payments have been made further widespread with the advent and growth of electronic commerce, also known as simply e-commerce. Through e-commerce, the sale of goods/services and other transactions can be conducted over a computer network, such as the Internet. In doing so, such transactions are made more efficient and convenient to both buyers and sellers in some cases due to the elimination of the overhead conventionally associated with maintaining a physical place of business.

Additionally, the efficiency of e-commerce enables expeditious processing of complex transactions, sometimes involving several parties, that otherwise would be cumbersome and time-consuming. As an example, a transaction for the sale of a particular product may involve a buyer, a merchant, retailer, or other entity that accepts the sale, a supplier or warehouse that physically provides the product to the buyer, a payment processor that facilitates the payment from the buyer to the seller to complete the sale through one or more financial networks, and/or other parties.

However, electronic payment systems that facilitate e-commerce transactions between parties are exposed to their own forms of risk. A particularly virulent strain of these risks lies in the recent increase in the sophistication and prevalence of hacker attacks on secure systems. Payment processors are a particularly appealing target for hackers because of the potential for monetary gains that may be obtained from spoofing the system into improperly transferring money out of the system. Common tactics employed by hackers involve obtaining the payment account information (user name, password, PIN, etc.) of a user through unauthorized means, for instance by intercepting communications between a user and a payment processor that contain the account information (commonly referred to as a “man-in-the-middle” attack) and/or by providing a user with a fraudulent prompt for account information that appears to originate from a user's chosen payment processing system but in actuality originates from and diverts the user's information to the hacker (i.e., “phishing”). For at least these reasons, it is advantageous for a payment processing system to enact measures to prevent a user's PIN or other payment account credentials from being compromised during a transaction.

### SUMMARY

The following disclosure relates to security measures for electronic payment systems, and more particularly, to security measures for electronic payment systems that utilize a third-party connection between a user and the payment system such that the user's payment account information is not exposed to any entity other than the payment system. Various embodiments thereof are better understood upon consideration of the detailed description below in conjunction with the accompanying drawings and claims.

An example of a computer-implemented method of facilitating a secure payment transaction to a first entity from a second entity is described below. The method includes providing a payment processing module to the first entity. The payment processing module is configured to integrate with a user interface provided by the first entity and to cause a payment processing interface to be embedded within the user interface, and the payment processing interface is hosted by a transaction server that is not controlled by the first entity. The method also includes obtaining information relating to the payment transaction, the information including at least an amount of the payment transaction. The method also includes configuring, at the transaction server, the payment processing interface for display within the user interface, such that the payment processing interface indicates the amount of the payment transaction and includes one or more prompts for the second entity to enter payment account information. The payment processing interface, when displayed, causes a remaining portion of the user interface to be displayed at a lesser level of focus than the payment processing interface. The method also includes receiving, at the transaction server from the second entity, encrypted payment account information in response to the one or more prompts. The encrypted user account information is encrypted by a client device controlled by the second entity and is sent directly from the client device to the transaction server without providing the encrypted payment account information to the first entity. The method also includes decrypting, at the transaction server, the encrypted payment account information, thereby obtaining decrypted payment account information. The method also includes processing, at the transaction server, the payment transaction using the decrypted payment account information. The method also includes providing, from the transaction server to the second entity, an indicator of success or failure of the payment transaction. The method also includes storing a record of the payment transaction at a data store associated with the transaction server for subsequent review by the first entity.

An example of a computer-based system for managing a secure payment transaction to a first entity from a second entity is described below. The system includes a memory storing instructions, a network interface, and a processor communicatively coupled to the memory and the network interface and configured to execute the instructions stored on the memory. The instructions, when executed, cause the processor to provide, to the first entity via the network interface, instructions for embedding a payment processing interface within a user interface provided by the first entity. The payment processing interface is hosted by a transaction server that is not controlled by the first entity. The instructions also cause the processor to obtain, via the network interface, information relating to the payment transaction, the information including at least an amount of the payment transaction. The instructions also cause the processor to configure the payment processing interface for display within the user interface, such that the payment processing interface indicates the amount of the payment transaction and includes one or more prompts for the second entity to enter payment account information. The payment processing interface, when displayed, causes a remaining portion of the user interface to be displayed at a lesser level of emphasis than the payment processing interface. The instructions also cause the processor to receive, from a client device controlled by the second entity via the network interface, encrypted payment account information in response to the one or more prompts. The encrypted user account information is encrypted by the client device and is sent directly from the client device to the transaction server without providing the encrypted payment account information to the first entity. The instructions also cause the processor to decrypt the encrypted payment account information, thereby obtaining decrypted payment account information. The instructions also cause the processor to process the payment transaction using the decrypted payment account information. The instructions also cause the processor to provide, to the second entity via the network interface, an indicator of success or failure of the payment transaction. The instructions also cause the processor to store a record of the payment transaction on the memory for subsequent review by the first entity.

Another example of a computer-implemented method of managing a monetary transaction between a first user and a second user is described below. The method includes initializing a transaction processing display that integrates with a user interface display and is maintained by a server that is not controlled by the first user. The method also includes populating the transaction processing display with transaction information and one or more prompts for authentication credentials from the second user. The transaction information includes at least an amount of the monetary transaction. The transaction processing display, when populated by the transaction information, is displayed at a higher level of prominence than a remaining portion of the user interface display. The method also includes receiving encrypted authentication credentials from the second user in response to the one or more prompts via a direct communication link with the second user that is inaccessible by the first user. The method also includes decrypting the encrypted authentication credentials. The method also includes processing the monetary transaction using the decrypted authentication credentials. The method also includes indicating a result of the monetary transaction to the second user. The method also includes recording the monetary transaction in a database for subsequent review by the first user.

DESCRIPTION OF DRAWINGS

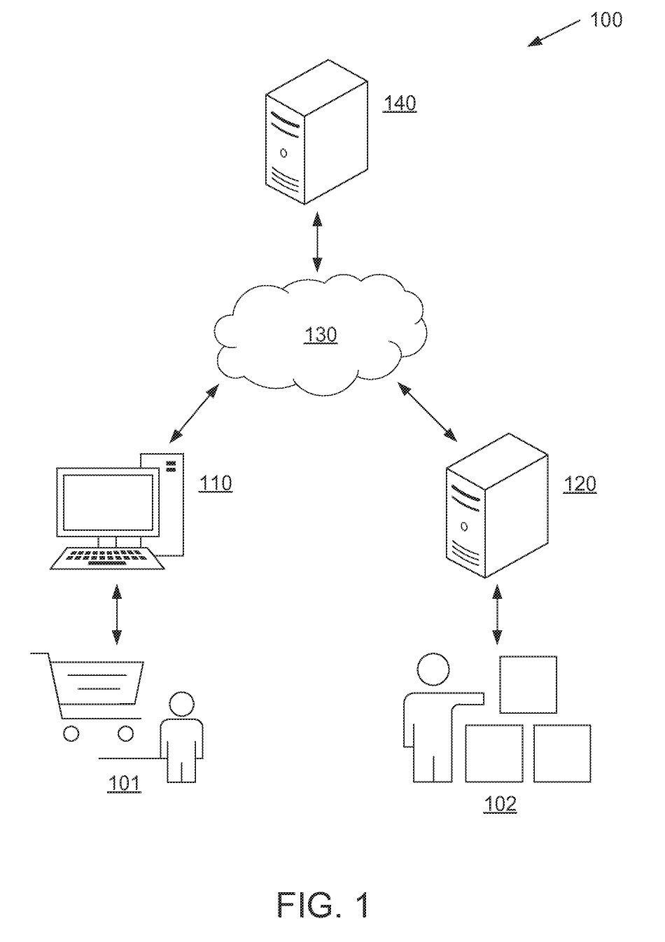

FIG. 1 is a network diagram of an example transaction processing system.

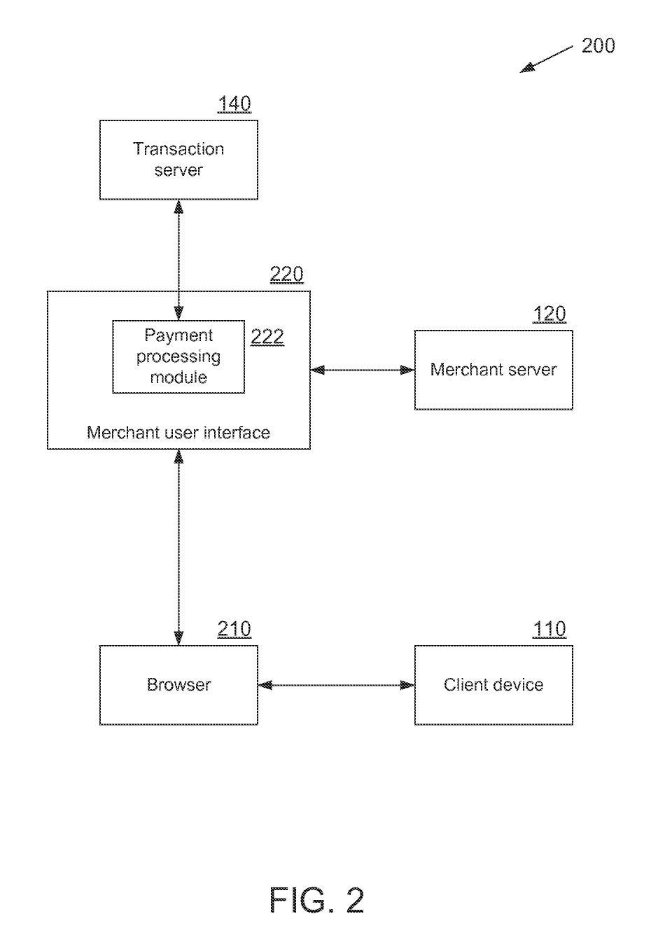

FIG. 2 is a block diagram of an example transaction processing system that provides for third-party interaction between a client and a payment processor within a user interface provided by a merchant.

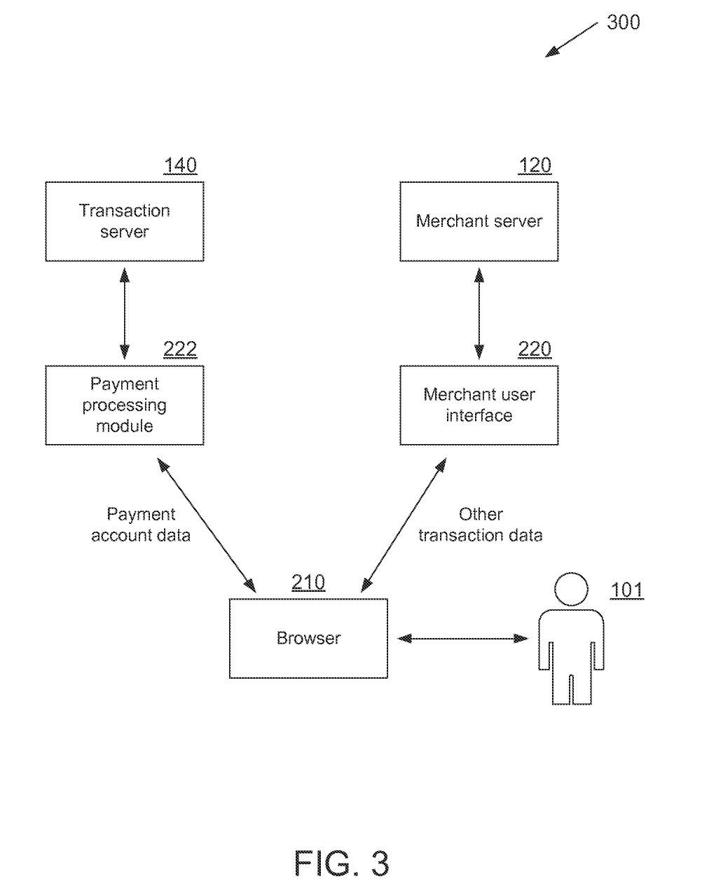

FIG. 3 is a block diagram showing flows of transaction-related information from a client to a merchant and a payment processor via the transaction processing system shown in FIG. 2.

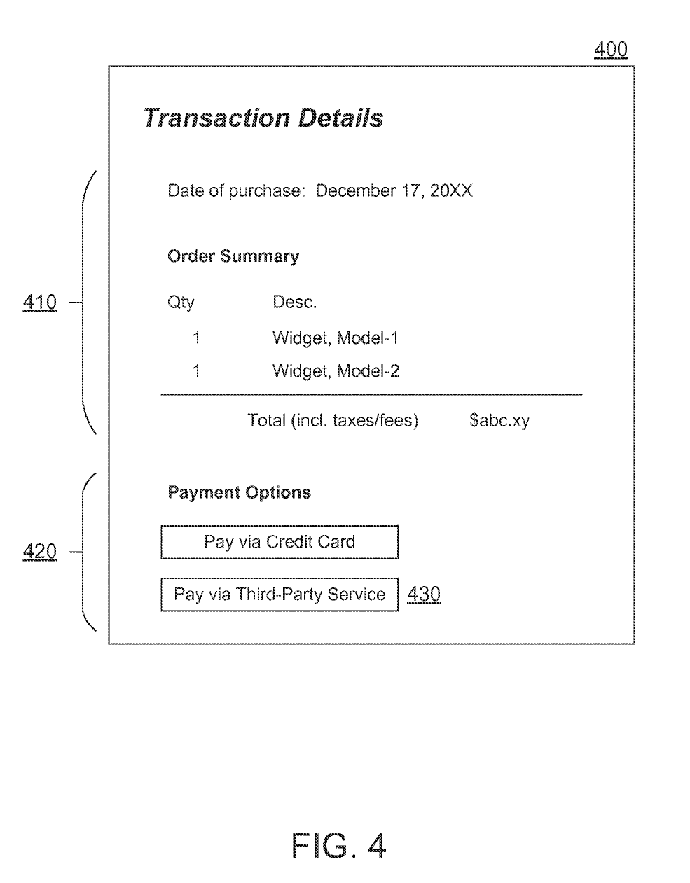

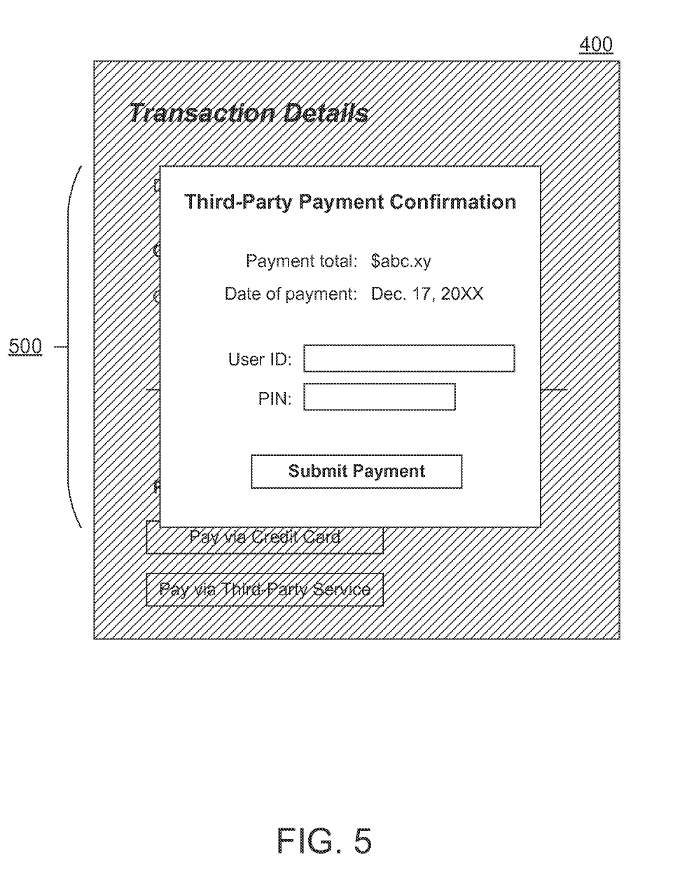

FIGS. 4-5 are illustrative views of an example implementation of a third-party payment processing interface embedded within the user interface of another entity.

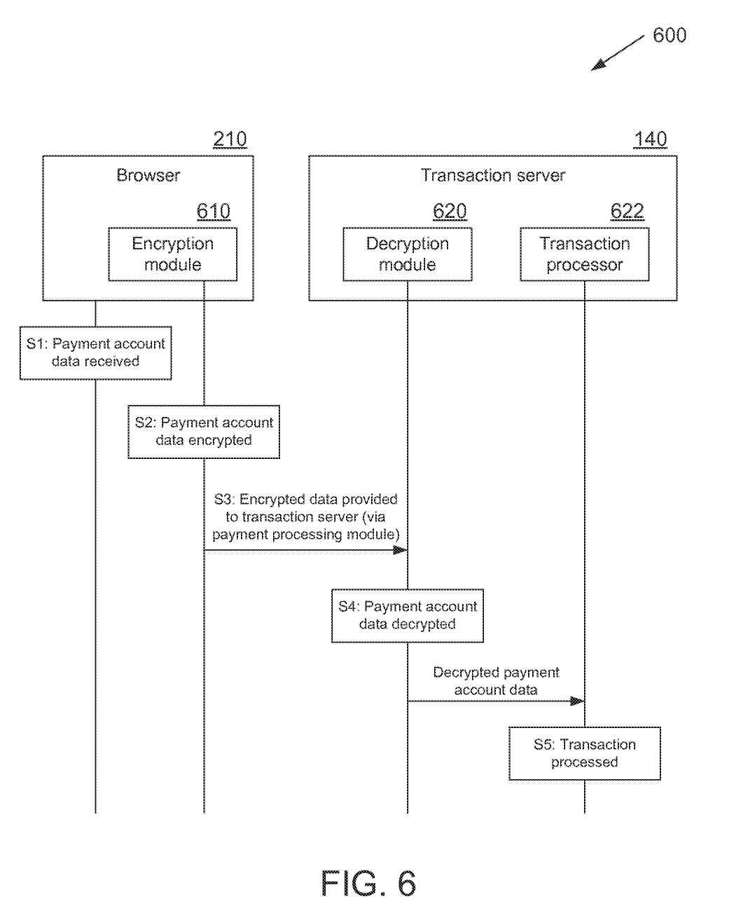

FIG. 6 is a communication flow diagram showing operations performed by a client browser and a transaction server in connection with the communications shown in FIG. 3.

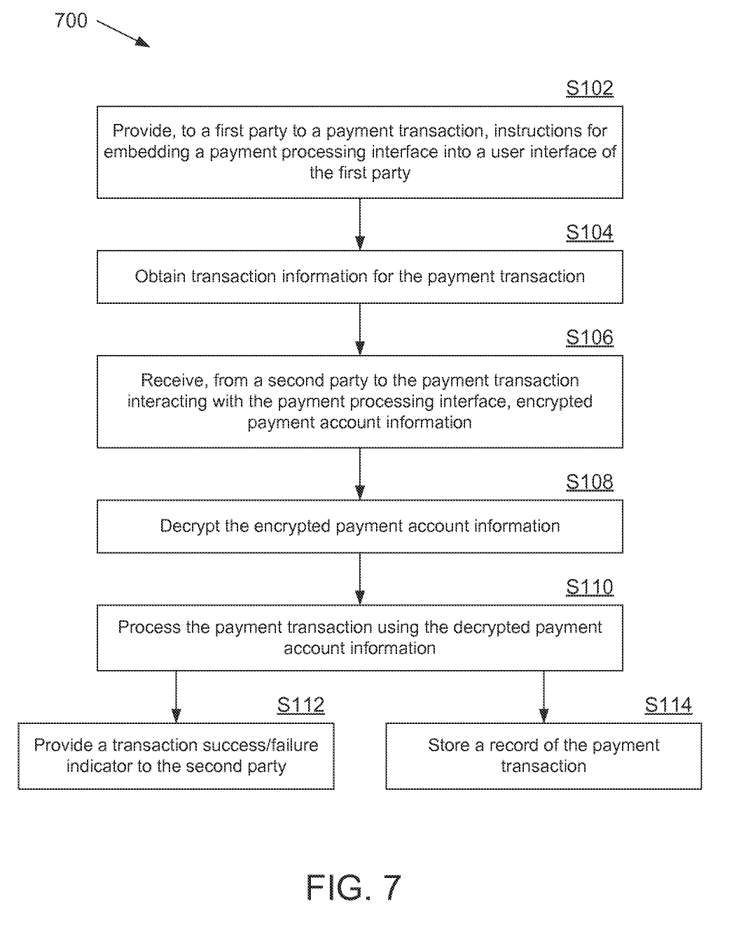

FIG. 7 is a flow diagram of an example transaction processing method.

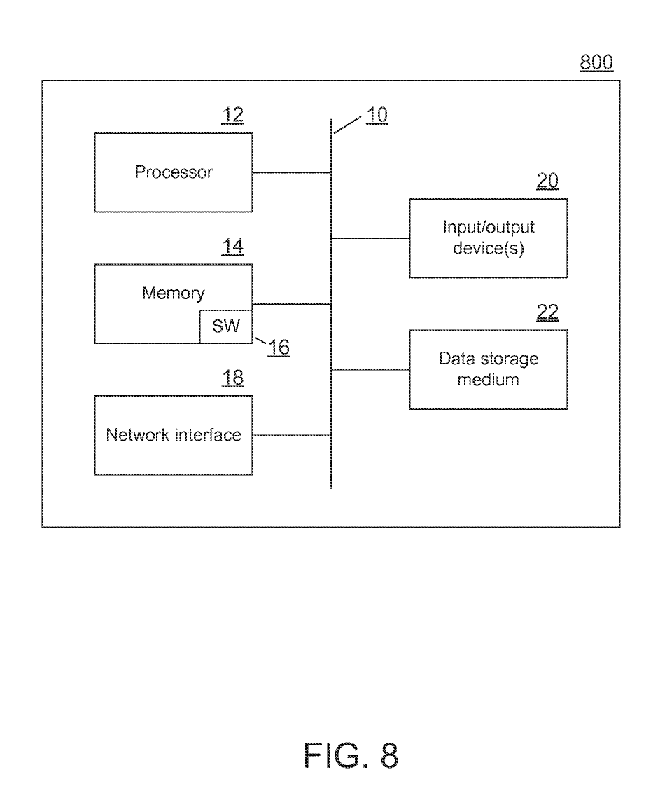

FIG. 8 is a block diagram of an example computing system that is operable to implement the features shown and described with respect to FIGS. 1-7.

### DETAILED DESCRIPTION

A detailed description of one or more embodiments is provided below along with figures that illustrate various aspects of said embodiments. In the drawings, like reference numbers refer to like components throughout.

FIG. 1 is a network diagram of an example transaction processing system 100. The diagram shows the transaction processing system 100 processing purchase/sale transactions and administrative transactions. However, the transaction processing system 100 can process other transactions, for example, loans, mortgages, rental payments, interest payments, dividend payments, grants, gifts, and even non-financial transactions.

A purchase/sale transaction can be initiated by system users, such as a consumer 101 and/or a merchant 102. For example, the consumer 101 can request a purchase of goods and services from the merchant 102, or the merchant 102 may directly initiate a sale of goods and services from the consumer 101. The consumer 101 and merchant 102 decide on various parameters, called transaction information, which can be included in a transaction request. The transaction request can include authentication information, a timestamp, merchant information, consumer information, goods and services information, or any other information related to the initiated transaction. Here, FIG. 1 illustrates a network-based transaction, in which the consumer 101 and merchant 102 conduct the transaction via respective electronic devices, e.g., a client device 110 and a merchant server 120, which are connected to each other via one or more networks 130, such as the Internet. Other transactions could also be performed without departing from the scope of FIG. 1. For instance, in a point-of-sale (POS) transaction, the merchant 102 would communicate with the network 130 via a POS terminal or another suitable device, whereas the consumer 101 conducts the transaction in person (i.e., without a client device 110) and may additionally utilize the same device used by the merchant 102 (e.g., by providing a signature or other authorization for the transaction to the POS terminal itself).

Once a transaction has been authorized by the consumer 101 and merchant 102, the corresponding transaction request is provided by the merchant server 120 to a transaction server 140 via the network 130. If the transaction is a purchase/sale transaction or otherwise involves a payment by the consumer 101, the transaction server 140 can at least partially process the payment. For instance, the transaction server 140 could be associated with, or be in communication with, one or more payment systems. A “payment system,” as used herein, refers generally to any system capable of effecting an electronic payment from a first party to a second party. Such systems may include, but are not limited to, banking systems, credit or charge card systems, third-party online payment providers, or the like. Further, it is assumed in the following description that the consumer 101 has established a payment account with at least one payment system with which the transaction server 140 is associated. If the user has not established such an account, the consumer 101 may be prompted to create an account prior to interacting with the transaction server 140. Alternatively, a temporary (guest) account may be created for the consumer 101 and used to process the transaction. In either of these cases, processing of the transaction would proceed using the newly-created account in a similar manner to that of a previously established account.

The transaction server 140 verifies the transaction information and the consumer's payment account information using techniques generally known in the art to ensure the validity of the transaction. For instance, the transaction server 140 may verify authentication credentials associated with the consumer's payment account to ensure that the transaction is an authorized use of the payment account. The transaction server 140 may also perform a balance check operation to ensure that an account balance associated with the consumer's payment account (e.g., bank account balance, payment account balance, credit card account balance) is sufficient to complete the transaction. The balance check operation may be performed by the transaction server 140 directly and/or by one or more external systems in communication with the transaction server 140. For instance, if the consumer 101 makes a payment via a bank account linked to a third-party payment system, the transaction server 140 for the third-party payment system may communicate with the banking system associated with the consumer's bank account to obtain an indication of whether the balance of the bank account is sufficient to complete the transaction.

If the transaction is successfully processed by the transaction server 140, the transaction server 140 approves and completes the transaction and notifies the consumer 101 and merchant 102 of the successful transaction. Otherwise, the transaction server 140 can return a failure condition to one or more of the consumer 101 or the merchant 102 in order to facilitate correction of the transaction information (e.g., correction of mistyped payment account information, etc.), to arrange alternate payment arrangements, and so on.

The transaction processing system 100 is not limited to processing purchase/sale transactions. As another example of a transaction, an administrative transaction can be initiated by system users such as the consumer 101 and merchant 102, who can be accountholders authorized to administer accounts through an account administration entity (not shown). For example, a first user can initiate an electronic funds transfer to a second user as a gift or grant. In such a case, a transaction request is constructed and sent to the transaction server 140 through the network 130. In a similar manner as described above, the transaction server 140 handles the transaction request by parsing the request and determining whether to access appropriate payment account data to effectuate the transaction request. If the payment account of the payor is configured to store a balance value for the account requested to be debited according to the transaction request, the transaction server 140 can determine if the account has sufficient funds to proceed as generally described above. If the transaction server 140 determines that the account has sufficient funds to proceed, the transaction server 140 can complete the transaction as described above and update information in payment accounts of the payor and/or payee as appropriate.

Turning next to FIG. 2, a simplified diagram 200 is provided that illustrates an e-commerce transaction between the consumer 101 and merchant 102 shown in FIG. 1. Similar to the system 100 shown in FIG. 1, the e-commerce transaction is conducted over one or more computer networks by a client device 110 operated or otherwise controlled by a consumer and a merchant server 120 controlled by a merchant 102. For simplicity and to emphasize the operations of the client device 110 and the merchant server 120 within diagram 200, the consumer 101 and merchant 102 are omitted from FIG. 2.

As further shown by FIG. 2, the client device 110 interacts with a browser 210 that facilitates the connection between the client device 110 and the merchant server 120. Upon establishing a connection to the merchant server 120, the client device 110 further utilizes the browser 210 to negotiate a transaction, e.g., a purchase and/or sale transaction, between the consumer 101 and merchant 102 via their respective devices 110, 120. To facilitate the negotiation between the consumer 101 and merchant 102, the merchant server 120 provides a merchant user interface 220 to the client device 110 via the browser 210. The merchant user interface 220 is a visual interface (e.g., a virtual catalog, an online storefront or product listing, etc.) displayed to the consumer 101, via the browser 210 running on the client device 110, in connection with a transaction between the consumer 101 and merchant 102.

In some cases, the browser 210 is a web browser application resident on or otherwise executed by the client device 110, such as the Internet Explorer® browser application created and distributed by Microsoft Corporation, the Safari® browser application created and distributed by Apple Inc., or the like. In such an implementation, the consumer 101 may initialize a sales transaction by navigating to a website hosted by the merchant server 120 (acting as a web server for the website) and/or otherwise controlled by the merchant 102, in which case the website is the merchant user interface 220 and includes product information and/or other information associated with sales transactions into which the consumer 101 and merchant 102 may enter. The consumer 101, via the browser 210, may subsequently browse product information located on the website, select one or more products, and initiate a purchase request for said products via one or more means as generally known in the art (e.g., adding items to a virtual shopping cart, initiating a checkout procedure, etc.).

The above scenario is one example in which the browser 210 shown in FIG. 2 is employed as a web browser. Other implementations could also be used. For instance, the browser 210 could additionally or alternatively be a messaging application, such as a short message service (SMS) or instant messaging application, an e-mail application, or any other browser application(s) sufficient to effectuate a legally binding contract between the consumer 101 and the merchant 102 by electronic means.

As noted above, the transaction between the consumer 101 and merchant 102 may be a sales transaction, in which the merchant 102 agrees to provide goods and/or services to the consumer 101 in exchange for a monetary payment by the consumer 101. Upon negotiation of the terms of an e-commerce transaction, either as described above and/or by other means generally known in the art, a payor of the transaction (here the consumer 101) generally provides the agreed-upon payment to a designated payee (here the merchant 102) via a payment account established between the payor and a payment processor. Consequently, the payment processor is the entity responsible for obtaining funds associated with the payment from the payor and providing said funds to the payee. In some cases, the payment processor for an e-commerce transaction between a consumer 101 and merchant 102 is the merchant 102 itself. Preferably, however, the payment processor is a third-party entity that is independent from the consumer 101 and merchant 102. The payment processor may be, or may be associated with, a financial institution, a third-party payment processing system, and/or other entity having sufficient access to infrastructure for electronically transferring funds from a first party to a second party.

At the time of payment associated with a transaction, the merchant 102 may identify to the consumer 101, via the merchant user interface 220, the payment processors and/or methods that are utilized by the merchant 102. The consumer 101 may then select a payment method from among those identified on the merchant user interface 220, e.g., by clicking a button corresponding to the selected payment method, filling out part of a web-based form associated with the selected payment method, and/or any other action(s) conveying an intent to provide payment for the transaction via the selected payment method.

If the consumer 101 elects to provide payment via a payment processor, the consumer 101 may be prompted to provide authentication credentials in order to access a payment account previously established between the consumer 101 and the payment processor. In turn, the payment account includes personal information, payment information, and/or other information to facilitate the payment from the consumer 101 to the merchant 102.

The following description assumes that the consumer 101 has previously established a payment account with the selected payment processor. If a payment account has not previously been established, the consumer 101 may be prompted to create one at the time of payment for a desired transaction. Alternatively, a temporary (guest) account could be created for the consumer 101 using information provided by the consumer 101. Processing of the transaction would then proceed as described below with respect to the newly-created payment account.

Account (authentication) credentials associated with a payment account are used to verify the identity of the user of the payment account and to verify that a given transaction is an authorized use of the payment account. These credentials may include an account identity, which may be a unique identifier (account number, username, etc.) or an identifier corresponding to the user (e.g., a user's email address or telephone number). In addition, the account credentials include includes security credentials, which may include a password, a personal identification number (PIN), or the like. In some cases, security credentials may also be paired with security challenge questions that require a user to provide pre-selected items of personal information (e.g., mother's maiden name, etc.).

The security of payment accounts and their corresponding account information is of paramount importance in the area of e-commerce. Because payment accounts are often associated with banking and other financial networks, these accounts and their associated information are regularly the target of hackers and other malicious parties. For instance, a malicious user may attempt to intercept account information as it is sent from the consumer 101 to the merchant 102. Alternatively, a malicious user may pass itself off as a payment processor used by the consumer 101 in order to obtain payment account information directly from the consumer 101 under false pretenses (a technique commonly known as “phishing”). Further, large-scale intrusions into merchant systems, while rarer than the attacks discussed above, are generally widely publicized and often have the effect of shaking consumer confidence in the security of e-commerce systems. Accordingly, security measures for an e-commerce application will preferably not only increase the security of a user's payment account, but will also actively assure the user that their account information is secured.

Returning to the example shown in FIG. 2, payment for the transaction between the consumer 101 and the merchant 102 is handled by a third-party transaction processor associated with a transaction server 140. As further shown by FIG. 2, the transaction server 140 generates and provides a payment processing module 222 that integrates with the merchant user interface 220 provided by the merchant server 120. The payment processing module 222 is visually located and operates within the merchant user interface 220 but collects and processes payment account information for the consumer 101 via a secured connection between the client device 110 and the transaction server 140 independently of the merchant 102 or its server 120. In doing so, payment account information for the transaction is exchanged only between the client device 110 and the transaction server 140, thereby reducing the amount of parties that have access to this information and consequently increasing the security of the information as it traverses the network.

Prior to the transaction between the consumer 101 and the merchant 102, the transaction server 140 is configured to provide instructions for utilizing the payment processing module 222 within the merchant user interface 220. These instructions may include, e.g., computer-executable program code that is configured to integrate with computer-executable program code stored at the merchant server for generating and rendering the merchant user interface. For instance, the code provided by the transaction server 140 to the merchant server 120 may be configured to be embeddable within code resident on the merchant server 120 corresponding a checkout portion of the merchant user interface 220, such as an e-commerce order form, a shopping cart, or the like. As an example, the instructions may be and/or otherwise include a script, which is configured to integrate with the merchant user interface 220 via addition of the script into an inline frame tag associated with the merchant user interface 220. Other instructions, code snippets, etc., configured to integrate the merchant user interface 220 and the payment processing module 222 could also be used. For succinctness of description, such program code provided from the transaction server 140 to the merchant server 120 for this purpose is referred to below as a “payment code portion” or simply “payment code.”

The payment processing module 222 may be visually integrated with the merchant user interface 220 using one or more techniques for jointly rendering multiple items in a common visual interface. In one example, the payment processing module 222 is (or includes) a script that is configured to integrate with the merchant user interface 220 via addition of the script into an inline frame tag associated with the merchant user interface. Other techniques could also be used. Further illustrative examples of the payment processing module 222 being integrated into the merchant user interface 220 are provided below.

As a result of the payment processing module 222 being integrated with the merchant user interface 220 as described above, the consumer 101 can interact with the merchant user interface 220 and the payment processing module 222 at the conclusion of a transaction as shown by diagram 300 in FIG. 3. The merchant user interface 220 and payment processing module 222 are illustrated separately in diagram 300 to illustrate functional differences between the two components 220, 222. Visually, however, the merchant user interface 220 and payment processing module 222 will appear to the consumer 101 as being integrated, as described above.

At the conclusion of an e-commerce transaction, the consumer 101 can opt to conduct payment for the transaction by interacting with the payment processing module 222 within the merchant user interface 220. In this state, the payment processing module 222 may include one or more control regions, such as buttons or other interactable objects, which initiate payment for the transaction via the transaction processor at the transaction server 140 upon engagement.

As an example of the above, FIG. 4 illustrates a merchant user interface 220, here visually represented as an online checkout form 400, in which a consumer 101 and merchant 102 are concluding a transaction for the sale of various widgets. The checkout form 400 includes a transaction details section 410, which displays information pertaining to the transaction such as the transaction (purchase) date, a listing of the items being sold, and a total purchase price for the transaction. Other and/or different information than that shown in FIG. 4 may also be displayed in the transaction details section 410.

The checkout form 400 further includes a payment options section 420. The payment options section 420 provides the consumer 101 with options for providing payment for the transaction from among payment methods accepted by the merchant 102. Among these options, a control region, here a button 430, provides the consumer 101 the option to pay via the third-party service associated with the transaction server 140. The button 430 is associated with the instructions provided by the transaction server 140 for providing the payment processing module 222 within the merchant user interface 220. Consequently, the button 430, when clicked by the consumer 101, causes the payment processing module 222 to be engaged within the user interface 220.

FIG. 5 illustrates the state of the checkout form 400 upon engagement of the payment processing module 222. When engaged, the payment processing module 222 opens a third-party payment window 500 that enables the consumer 101 to enter authentication credentials for a payment account associated with the transaction server 140, such as a user identifier (username, phone number, etc.) and PIN. As shown in FIG. 5, the payment window 500 may also include information pertaining to the transaction, such as the transaction date or amount.

Although the payment window 500 shown in FIG. 5 is visually embedded within the checkout form 400 hosted by the merchant 102 in the interest of providing a seamless user experience, the payment window 500 is separately hosted by the transaction server 140 and is separately secured using security certificates (e.g., Secure Sockets Layer (SSL) certificates or the like) maintained at the transaction server 140. Accordingly, the payment window 500 serves as a consumer portal for the associated third-party payment service, which is visually embedded into the merchant's user interface but fully hosted at the transaction server 140 and protected by security certificates for the payment service.

As mentioned previously, while the payment window 500 may include information pertaining to the transaction, the payment window 500 is separately hosted by the transaction server 140 and not the merchant server 120. As such, the transaction details are either passed from the merchant server 120 to the transaction server 140 for ultimate display in the browser 210 or added to the payment window 500 by the browser 210 itself. The transaction details can be passed to the transaction server 140 in exchange for a transaction identifier that is sent to the transaction server 140 from the browser 210 when the payment window 500 is called for display. The transaction identifier is assigned by the merchant server 120 and associated with the transaction details. This approach allows the merchant to retain direct control of the transaction details all the way through presentation of the final request for confirmation from the consumer even though the transaction is being approved via direct communication with the browser 210 and transaction server 140. In the alternative, the browser 210 can execute a code snippet when the payment window 500 is called for display that passes the transaction details directly from the browser's cache into the payment window 500. The code snippet can alter the code received from the transaction server 140 to include these details, or it can define variables that are referenced by the code that is provided by the transaction server 140 for rendering the payment window 500.

As discussed in further detail below, separately hosting and securing data associated with the payment window 500 enables a payment to a merchant to be processed without exposing any payment account information to the merchant or other third parties. As additionally shown in FIG. 5, this separation of functions between the merchant server 120 and the transaction server 140 is visually indicated by creating a visual distinction between the checkout form 400 and the payment window 500 when the payment window 500 is active. Specifically, the payment window 500, when displayed, is displayed at a higher level of emphasis than the checkout form 400. In the example shown in FIG. 5, this is achieved by darkening the checkout form 400 when the payment window 500 is displayed. Also or alternatively, the checkout form 400 could be blurred and/or otherwise de-emphasized in any other manner sufficient to show a visual distinction between the checkout form 400 and the payment window 500 when the payment window 500 is displayed.

As a result of the merchant user interface 220 and payment processing module 222 being independently hosted and implemented, a consumer 101 or other user can interact with and exchange information with both the merchant server 120 and transaction server 140 via a single browser session. This is shown functionally in FIG. 3. As further shown by FIG. 3, because each of the merchant user interface 220 and payment processing module 222 are separately implemented, the consumer 101 can, via the browser 210, provide payment account data to the transaction server 140 via the payment processing module 222 and other transaction data to the merchant server 120 via the merchant user interface without providing or exposing said data to other entities and/or between the servers 120, 140.

The flow of payment account information between the browser 210 and transaction server 140 for an example payment transaction is illustrated by diagram 600 in FIG. 6. At stage S1, payment account data is received by the browser 210, e.g., from the consumer 101 and/or someone authorized to act on the consumer's behalf

At stage S2, the payment account data received at stage S1 are encrypted by the browser 210. Here, the browser 210 includes an encryption module 610, which may include computer-executable code operable to cause a processor to perform one or more encryption operations on the payment account data. The encryption module 610 may further include encryption keys established between the browser and the transaction server and/or other suitable information.

At stage S3, the payment account data encrypted at stage S2 are transmitted securely and directly to the transaction server 140 (via the payment processing module 222, as described above), bypassing the merchant server 120 and/or any other network entities controlled by the merchant 102. By transmitting the data in this manner, secure data do not touch any servers other than the transaction server 140 or other servers controlled by the associated payment service.

At stage S4, the transaction server 140 decrypts the payment account information received at stage S3. Here, the transaction server 140 includes decryption module 620, which is structured and configured in a similar manner to the encryption module 610 of the browser 210 to decrypt the received data using similar techniques and encryption keys/data to those used by the encryption module 610.

Upon successful decryption, the decrypted payment account data is further provided to a transaction processor 622 at the transaction server 140, which processes the transaction at stage S5. The transaction processor 622 includes one or more hardware or software components operable to process a requested transaction according to the provided payment account details. For instance, the transaction processor 622 may perform actions such as authenticating a user based on the received payment account data, checking whether an account balance associated with the user is sufficient to cover the requested transaction, and/or other transaction processing operations generally known in the art. The transaction processor 622 may further indicate the status (e.g., success or failure) of processing the transaction to the merchant 102. Depending on this status, the merchant 102 may opt to accept the order, display an error message at the merchant user interface 220, and/or take other actions.

Referring next to FIG. 7, with further reference to FIGS. 1-6, a process 700 of facilitating a secure payment transaction to a first entity (e.g., a merchant 102) from a second entity (e.g., a consumer 101) includes the stages shown. The process 700 is, however, an example only and not limiting. For instance, the process 700 could be altered, e.g., by having stages added, removed, rearranged, combined, and/or performed concurrently. Still other alterations to the process 700 as shown and described are possible.

At stage S102, instructions for embedding a payment processing interface 222 into a user interface of the first party (e.g., the merchant user interface 220) are provided to the first party. As described above, these instructions may include a script or other payment code portion configured to enable a sub-interface controlled by the transaction server 140 within the merchant user interface 220 hosted by the merchant server 120. The instructions may be conveyed at stage S102 directly from the transaction server 140 to the merchant server 120, e.g., via a network connection between the respective servers 120, 140, or indirectly. For instance, the instructions could also be provided to the merchant 102 or a representative thereof on a physical medium (e.g., floppy disk, CD, DVD, memory card, etc.) and implemented at the merchant server 120 via the physical medium. Other means for providing the instructions to the first party to the transaction at stage S102 could also be used.

At stage S104, transaction information for the payment transaction is obtained, e.g., by the transaction server via the payment processing module 222. This information may include any information pertaining to the transaction, such as a date/time of the transaction, a monetary cost of the transaction, identities of the parties to the transaction, and/or any other information sufficient to enable the transaction server 140 to properly process the transaction.

At stage S106, encrypted payment account information is received from a second party to the transaction interacting with the payment processing module 222. The payment account information may be received directly from the second party, e.g., in response to a visual prompt for the payment account information displayed at the payment processing module 222, and/or automatically from a computing device operated by the second party and/or one or more portions thereof (e.g., saved login information, cookies, etc.). The payment account information is encrypted at the second party's device, e.g., via the browser 210 of said device as shown in FIG. 6, and received in encrypted form from said device. Receiving the payment account information may also include establishing a secure communication link to the second party's device according to one or more security protocols and receiving the encrypted payment account information over this secure communication link.

At stage S108, the encrypted payment account information is decrypted, e.g., at the transaction server 140 and/or another entity associated with the transaction server 140. For instance, the transaction server 140 may include a decryption module 620 configured to decrypt the received data as described above with respect to FIG. 6. Other techniques for decrypting the payment account information could also be used.

At stage S110, the payment transaction is processed using the decrypted payment account information obtained at stage S108. Processing of the transaction at stage S110 may include verifying the payment account information received at stage S106, checking an account balance associated with the corresponding payment account against an amount of the transaction, and/or any other operations associated with effectuating the transaction between the first and second parties.

Following stage S110, an indicator of success or failure of the transaction is returned to the second party at stage S112. This indicator could be a message or other visual indicator displayed on the user interface of the first party and/or the payment processing module 222 showing whether the transaction completed successfully. Alternatively, the indicator may be an indirect indicator, such as a uniform resource locator (URL) to a network location containing the indicator. The indicator returned at stage S112 may include additional information, such as a confirmation of the transaction details in the case of a successful transaction or error messages in the case of a failed transaction. The indicator may also include a prompt for the second party to attempt to re-enter their payment account details, e.g., in the case of a failed transaction due to incorrect payment account information. Further, the indicator returned at stage S112 may be provided directly from the payment handler for the transaction (e.g., the transaction server 140) to the second party, or alternatively the indicator may be provided from the payment handler to the first party such that the first party can elect what, if any, further steps are to be taken to complete the transaction.

Additionally following stage S110, a record of the payment transaction is stored at stage S114. In the case of the transaction server 140 executing process 700, this record may be stored locally at a data storage medium associated the transaction server 140 and/or on a database server or other distinct computing device or combination of devices that are communicatively coupled to the transaction server 140 via a wired or wireless connection. The record may include a transaction date, transaction amount, and/or any other information that is desirably maintained by the payment handler or either party to the transaction. In some cases, records associated with both successful and failed transactions are stored; alternatively, records for successful transactions may be stored while records for failed transactions are discarded. Further, the record may be stored as part of a data structure, such as a payment confirmation status table and/or another suitable structure, corresponding to an individual entity (e.g., the merchant 102) or multiple entitites.

Subsequent to storing a record of the transaction as described at stage S114, the record may be made available to one or more parties to the transaction. For instance, for a transaction between a consumer 101 and merchant 102, a record of the transaction may be stored at stage S114 for subsequent access by the merchant 102. The transaction record, along with other transaction records involving the merchant 102, may be stored as a database and/or other logical data structure that is made accessible to the merchant 102 via the transaction server 140. The merchant 102 may access transaction records via the database or other structure either upon request (e.g., via a query function or other suitable tools), or upon predetermined intervals. For instance, a statement or other report may be provided to the merchant 102 at regular intervals (e.g., quarterly, monthly, etc.) that includes some or all of the stored transaction records involving the merchant 102 for that time period.

Turning next to FIG. 8, an example computing device 800 operable to perform some or all of the operations described above is illustrated. The computing device 800 may be implemented, either wholly or in part, by the client device 110, merchant server 120, and/or transaction server 140 as described above, and/or by any other devices configurable to perform the functions described above. Further, while the computing device 800 is illustrated as having various components, one or more computing devices employed to perform computer-implemented functions as described above may include components that are different from and/or additional to the components shown in FIG. 8 and/or omit components shown in FIG. 8.

The computing device 800 shown in FIG. 8 includes a processor 12, a memory 14 storing software 16, a network interface 18, input/output device(s) 20 (e.g., a display, speaker, keyboard or keypad, mouse, touch screen or touchpad, etc.), and a data storage medium 22, each of which are in communication with each other via a data bus 10. The data bus 10 comprises interfaces between the various components of the computing device 800 and may be implemented either wholly or in party via one or more bus protocols such as Universal Serial Bus (USB), FireWire, ATA or Serial ATA (SATA), and/or any other suitable protocols either presently existing or developed in the future.

The processor 12 is an intelligent hardware device, e.g., a central processing unit (CPU) such as those made by Intel® Corporation or AMD®, a microcontroller, an application specific integrated circuit (ASIC), etc. The memory 14 includes non-transitory storage media such as random access memory (RAM) and/or read-only memory (ROM). The memory 14 stores the software 16, which is computer-readable, computer-executable software code containing instructions that are configured to, when executed, cause the processor 12 to perform various functions described herein. Alternatively, the software 16 may not be directly executable by the processor 12 but nonetheless be configured to cause the computing device 800, e.g., when compiled and executed, to perform the functions.

The network interface 18 includes appropriate equipment for sending and receiving data over a computer network, such as the network 130. The network interface is configured to enable communication by the computing device 800 according to one or more wired or wireless communication protocols either currently known in the art or developed in the future. Such protocols could include, but are not limited to, Bluetooth, WiFi, the Third Generation Partnership Project (3GPP) third-generation (3G) or fourth-generation (4G) standards, etc.

The data storage medium 22 comprises a non-transitory, machine readable medium for storing data generated and/or otherwise desirably associated with the computing device 800. The data storage medium 22 may comprise one or more types of physical (non-transitory) computer-readable media. While the data storage medium 22 is illustrated in FIG. 8 as a separate entity to the memory 14, in some implementations the memory 14 and data storage medium 22 may share common physical components or be the same physical component. Further, while the data storage medium 22 is illustrated in FIG. 8 as an internal component to the computing device 800, the data storage medium 22 may alternatively be an external data store that is communicatively coupled to the computing device 800 via an external bus protocol such as USB, Firewire, External Serial ATA (eSATA), or the like. In still other alternative implementations, an external storage medium may include its own network interface for transferring data between itself and the computing device 800 via a network connection with the network interface 18 of the computing device 800.

While the above disclosure is provided in detail with respect to specific embodiments discussed therein, it should be appreciated that those skilled in the art, upon attaining an understanding of the foregoing description, may readily conceive of alterations to, variations of, and equivalents to the one or more described embodiments. These and other modifications and variations to the subject matter disclosed herein may be practiced by those of ordinary skill in the art, without departing from the spirit and scope of said subject matter. Furthermore, those of ordinary skill in the art will appreciate that the foregoing description is by way of example and not limitation. Thus, it is intended that the present subject matter covers such modifications and variations.

The embodiments disclosed above can be implemented in numerous ways, including as an apparatus, a system, a device, a computer-implemented method, and/or a computer-readable medium. A non-transitory computer-readable storage medium stores computer-readable instructions or other program code, which when executed by one or more processors, cause a computer to perform a method in accordance with the one or more embodiments. Examples of a medium includes, but is not limited to, circuit-based media (e.g., read-only memory, flash memory, solid-state drive), magnetic media (e.g., hard drive, tape, floppy disk, magstripe card), optical media (e.g., compact disc, digital versatile disc, Blu-ray Disc), and any combination of such media. A system is a computer-based system with one or more processors executing instructions on one or more network-attached nodes. A processor can be any hardware-based processing device including, but not limited to, a central processing unit with one or more cores, a reduced-instruction set processor, a field-programmable gate array, a general purpose graphics processing unit, and any combination of such processing devices. A network can run over any physical communications medium, including, but not limited to, Ethernet, WiFi, infrared, universal serial bus, optical fiber, Bluetooth, telephone network, bus interfaces, and any combination of such physical communications media. Data can be stored in any known format, such as in a database (e.g., managed by a database management system, or in files on a file system). As used herein, the term “database” encompasses any computer-readable data storage mechanism, and the term “table” encompasses any logical data structure configured to store data. It should be appreciated that the exact implementation is not limited to any single particular hardware or software configuration.

1. A computer-implemented method of facilitating a secure payment transaction to a first entity from a second entity, the method comprising:
providing a payment processing module to the first entity, wherein the payment processing module is configured to integrate with a user interface provided by the first entity and to cause a payment processing interface to be embedded within the user interface, the payment processing interface being hosted by a transaction server that is not controlled by the first entity;
obtaining information relating to the payment transaction, the information comprising at least an amount of the payment transaction;
configuring, at the transaction server, the payment processing interface for display within the user interface, wherein the payment processing interface indicates the amount of the payment transaction and comprises one or more prompts for the second entity to enter payment account information, and wherein the payment processing interface, when displayed, causes a remaining portion of the user interface to be displayed at a lesser level of focus than the payment processing interface;
receiving, at the transaction server from the second entity, encrypted payment account information in response to the one or more prompts, wherein the encrypted payment account information is encrypted by a client device controlled by the second entity and is sent directly from the client device to the transaction server without providing the encrypted payment account information to the first entity;
decrypting, at the transaction server, the encrypted payment account information, thereby obtaining decrypted payment account information;
processing, at the transaction server, the payment transaction using the decrypted payment account information;
providing, from the transaction server to the second entity, an indicator of success or failure of the payment transaction; and
storing a record of the payment transaction at a data store associated with the transaction server for subsequent review by the first entity.

2. The computer-implemented method of claim 1, wherein receiving the encrypted payment account information comprises receiving the encrypted payment account information from a browser application executed by the second entity at the client device.

3. The computer-implemented method of claim 2, wherein:
receiving the encrypted payment account information comprises:
establishing, at the transaction server, a secure communication link to the client device via a security protocol; and
receiving the encrypted payment account information via the secure communication link, wherein the encrypted payment account information is encrypted according to the security protocol; and
decrypting the encrypted payment account information comprises decrypting the encrypted payment account information according to the security protocol.

4. The computer-implemented method of claim 2, wherein providing the indicator of success or failure of the payment transaction comprises returning a uniform resource locator (URL) to the browser application, the URL directing the browser application to the indicator.

5. The computer-implemented method of claim 1, wherein the user interface includes a control region, the control region being configured to respond to engagement thereof by triggering display of the payment processing interface.

6. The computer-implemented method of claim 1, wherein the payment processing module comprises a script that is configured to integrate with the user interface via addition of the script into an inline frame tag associated with the user interface.

7. The computer-implemented method of claim 1, wherein configuring the payment processing interface comprises configuring the payment processing interface to include a first prompt for payment account identity information and a second prompt for authentication credentials.

8. The computer-implemented method of claim 1, wherein processing the payment transaction comprises:
identifying a payment account associated with the second entity using the decrypted payment account information; and
checking an account balance of the payment account against the amount of the payment transaction.

9. The computer-implemented method of claim 1, wherein configuring the payment processing interface comprises securing the payment processing interface using first security credentials established between the transaction server and the second entity, the first security credentials being distinct from second security credentials established between the first entity and the second entity.

10. The computer-implemented method of claim 1, further comprising providing a second indicator of success or failure of the payment transaction from the transaction server to the first entity independently of storing the record of the payment transaction.

11. The computer-implemented method of claim 1, wherein the first entity is a merchant entity and the second entity is a consumer entity.

12. The computer-implemented method of claim 1, wherein:
the user interface is included in a website provided by the first entity;
the website is hosted by a web server of the first entity; and
the web server of the first entity is distinct from the transaction server.

13. The computer-implemented method of claim 1, further comprising:
adding the record of the payment transaction to a payment confirmation status table associated with the first entity; and
providing the payment confirmation status table to the first entity in response to the payment confirmation status table being requested by the first entity.

14. A computer-based system for managing a secure payment transaction to a first entity from a second entity, the system comprising:
a memory storing instructions;
a network interface; and
a processor communicatively coupled to the memory and the network interface and configured to execute the instructions stored on the memory, wherein the instructions, when executed, cause the processor to:
provide, to the first entity via the network interface, instructions for embedding a payment processing interface within a user interface provided by the first entity, the payment processing interface being hosted by a transaction server that is not controlled by the first entity;
obtain, via the network interface, information relating to the payment transaction, the information comprising at least an amount of the payment transaction;
configure the payment processing interface for display within the user interface, wherein the payment processing interface indicates the amount of the payment transaction and comprises one or more prompts for the second entity to enter payment account information, and wherein the payment processing interface, when displayed, causes a remaining portion of the user interface to be displayed at a lesser level of emphasis than the payment processing interface;
receive, from a client device controlled by the second entity via the network interface, encrypted payment account information in response to the one or more prompts, wherein the encrypted payment account information is encrypted by the client device and is sent directly from the client device to the transaction server without providing the encrypted payment account information to the first entity;
decrypt the encrypted payment account information, thereby obtaining decrypted payment account information;
process the payment transaction using the decrypted payment account information;
provide, to the second entity via the network interface, an indicator of success or failure of the payment transaction; and
store a record of the payment transaction on the memory for subsequent review by the first entity.

15. The computer-based system of claim 14, wherein the encrypted payment account information is received from a browser application executed by the second entity at the client device.

16. The computer-based system of claim 15, wherein the instructions are further configured to cause the processor to provide a uniform resource locator (URL) to the browser application, the URL directing the browser application to the indicator of success or failure of the payment transaction.

17. The computer-based system of claim 14, wherein the user interface is hosted by a web server controlled by the first entity, the web server being distinct from the transaction server.

18. The computer-based system of claim 14, wherein the instructions are further configured to cause the processor to provide a script to the first entity, and wherein the payment processing interface is embedded within the user interface via addition of the script into an inline frame tag associated with the user interface.

19. A computer-implemented method of managing a monetary transaction between a first user and a second user, the method comprising:
initializing a transaction processing display, wherein the transaction processing display integrates with a user interface display and is maintained by a server that is not controlled by the first user;
populating the transaction processing display with transaction information and one or more prompts for authentication credentials from the second user, the transaction information including at least an amount of the monetary transaction, wherein the transaction processing display, when populated by the transaction information, is displayed at a higher level of prominence than a remaining portion of the user interface display;
receiving encrypted authentication credentials from the second user in response to the one or more prompts via a direct communication link with the second user that is inaccessible by the first user;
decrypting the encrypted authentication credentials;
processing the monetary transaction using the decrypted authentication credentials;
indicating a result of the monetary transaction to the second user; and
recording the monetary transaction in a database for subsequent review by the first user.
